(19) United States
(12) Patent Application Publication
(10) Pub. No.: US 2026/0058322 A1
(43) Pub. Date: Feb. 26, 2026

(54) BUS BAR MODULE CASE AND BUS BAR MODULE

(71) Applicant: YAZAKI CORPORATION, Tokyo (JP)

(72) Inventors: Katsunori Sato, Makinohara-shi (JP); Tatsuya Oga, Makinohara-shi (JP); Mariko Nakagawa, Makinohara-shi (JP); Seigo Mochizuki, Fujieda-shi (JP)

(21) Appl. No.: 19/305,640

(22) Filed: Aug. 20, 2025

(30) Foreign Application Priority Data
Aug. 22, 2024 (JP) 2024-140727

(51) Int. Cl. H01M 50/503; H01M 50/507

(52) U.S. Cl. CPC H01M 50/503; H01M 50/507

(57) ABSTRACT

A bus bar module case includes a bus bar cavity that accommodates therein a bus bar connecting electrodes of battery cells in a plurality of the battery cells arranged side by side and includes a side wall erected around an end edge of the bus bar, and the side wall is provided with a drain hole that communicates an inside and an outside of the bus bar cavity. In addition, a bus bar module includes the bus bar, a wiring member, and the bus bar module case. An edge portion of the drain hole includes tapered guide portions inclined so as to reduce a cross-sectional area of the drain hole from the inside to the outside of the bus bar cavity.

### CROSS-REFERENCE TO RELATED APPLICATIONS

The present application claims priority to and incorporates by reference the entire contents of Japanese Patent Application No. 2024-140727 filed in Japan on August 22, 2024.

### BACKGROUND OF THE INVENTION

### 1. Field of the Invention

The present invention relates to a bus bar module case and a bus bar module.

### 2. Description of the Related Art

As a technique relating to a bus bar module case and a bus bar module in the related art, for example, Japanese Patent Application Laid-open No. JP 2014 - 093 218 A discloses a bus bar module that is attached to a side surface of a battery assembly to constitute a power supply device. The bus bar module includes a case, and the case includes a plurality of bus bar accommodating units, a voltage detection terminal provided adjacent to each bus bar accommodating unit, a wiring unit for arranging a voltage detection line connected to the voltage detection terminal, and a cover for covering a predetermined range of the wiring unit.

Incidentally, such a bus bar module case and a bus bar module are required to appropriately perform treatment such as discharge of water droplets from a bus bar cavity of a bus bar accommodating unit or the like, for example, when the bus bar is condensed to generate the water droplets. The bus bar module case and the bus bar module have room for further improvement in the treatment of water droplets accumulated in the bus bar cavity.

### SUMMARY OF THE INVENTION

The present invention has been made in view of the above circumstances, and an object thereof is to provide a bus bar module case and a bus bar module capable of appropriately realizing treatment of water droplets accumulated in a bus bar cavity.

In order to achieve the above mentioned object, a bus bar module case according to one aspect of the present invention includes a bus bar cavity that accommodates therein a bus bar connected to an electrode of each of a plurality of battery cells arranged side by side, and includes a side wall erected around an end edge of the bus bar, wherein the side wall is provided with a drain hole that communicates an inside and an outside of the bus bar cavity, and the drain hole has an edge portion including a tapered guide portion inclined to reduce a cross-sectional area of the drain hole from the inside to the outside of the bus bar cavity.

In order to achieve the above mentioned object, a bus bar module according to another aspect of the present invention includes a bus bar connected to an electrode of each of a plurality of battery cells arranged side by side; a wiring member electrically connected to the bus bar; and a bus bar module case including a bus bar cavity that accommodates therein the bus bar and includes a side wall erected around an end edge of the bus bar, in which the side wall is provided with a drain hole that communicates an inside and an outside of the bus bar cavity, and the drain hole has an edge portion including a tapered guide portion inclined to reduce a cross-sectional area of the drain hole from the inside to the outside of the bus bar cavity.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a state in which a cover of a bus bar module according to an embodiment is open;

FIG. 2 is a perspective view illustrating a state in which the cover of the bus bar module according to the embodiment is closed;

FIG. 3 is a perspective view of a bus bar module case according to the embodiment when viewed from a battery cell side; and

FIG. 4 is a sectional view taken along line IV-IV of FIG. 3.

### DETAILED DESCRIPTION OF THE PREFERRED EMBODIMENTS

Hereinafter, an embodiment according to the present invention will be described in detail with reference to the drawings. The present invention is not limited by the embodiment. In addition, components in the following embodiment include those that can be easily replaced by those skilled in the art or those that are substantially the same.

### Embodiment

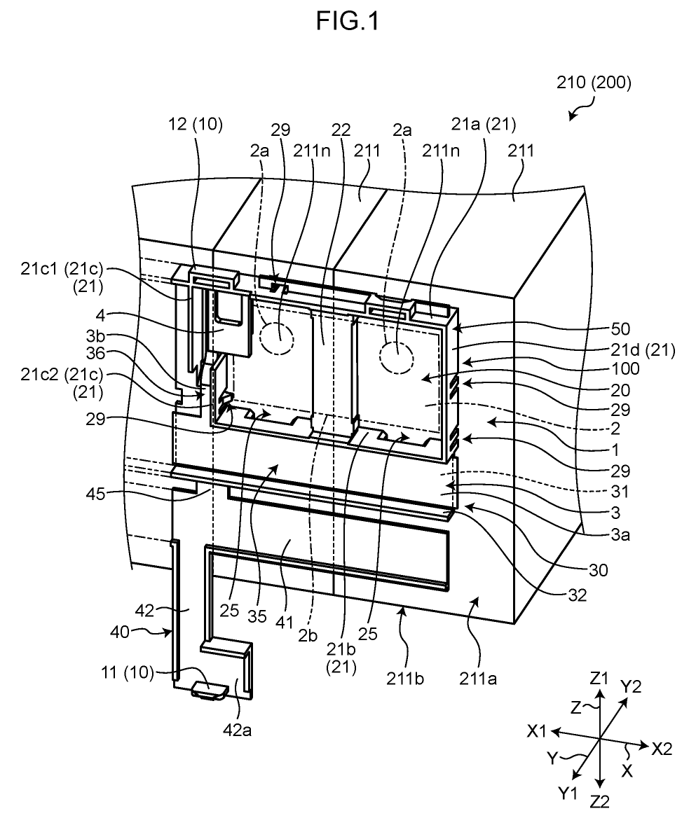

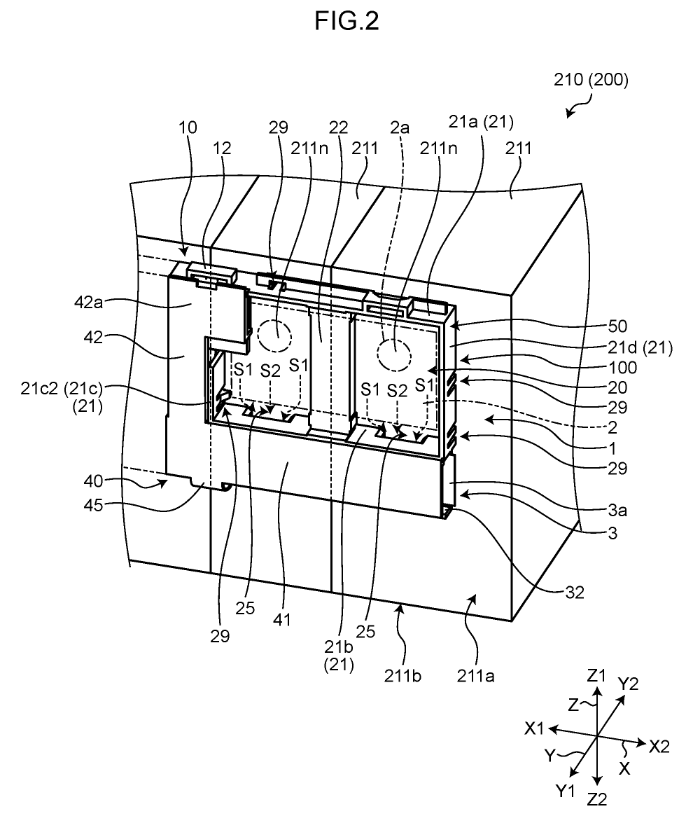

As illustrated in FIGS. 1 and 2, a battery module 210 of the present embodiment includes a plurality of battery cells 211 and a bus bar module 1. The battery module 210 of the present embodiment is a component of a battery pack 200. The battery pack 200 may include a plurality of the battery modules 210. The battery pack 200 is mounted as a power source on a vehicle such as an electric vehicle or a hybrid electric vehicle, for example.

In the following description, a direction in which the plurality of battery cells 211 is arranged side by side is referred to as a first direction X, and two directions orthogonal to the first direction X are referred to as a second direction Y and a third direction Z. The third direction Z is a direction perpendicular to an installation surface 211b of the plurality of battery cells 211. In the following description, one side in the first direction X is referred to as a first side X1, and the other side is referred to as a second side X2. Similarly, the second direction Y is referred to as a first side Y1 and a second side Y2, and the third direction Z is referred to as a first side Z1 and a second side Z2. In the following description, the third direction Z may be referred to as a vertical direction, the first side Z1 may be referred to as an upper side, and the second side Z2 may be referred to as a lower side.

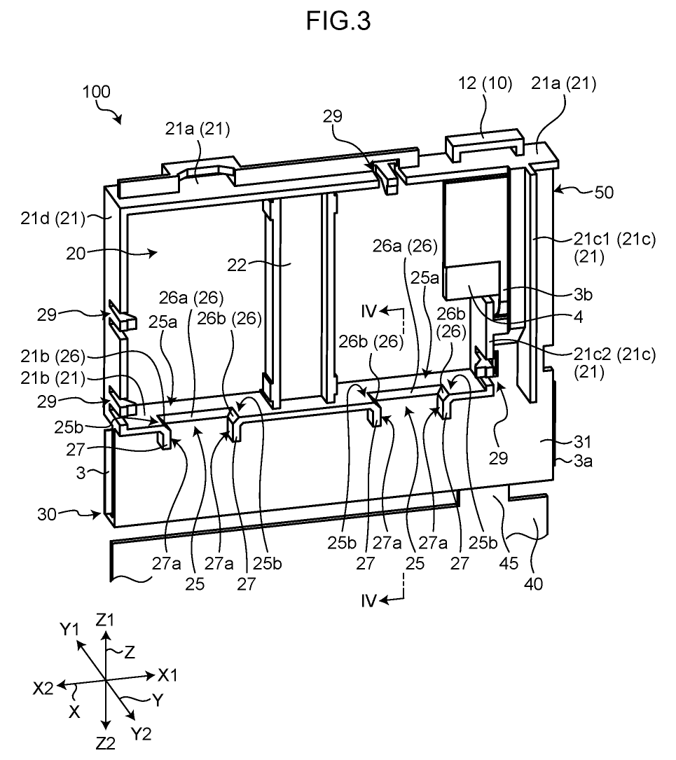

The battery cells 211 constitute a so-called unit battery and constitute an assembled battery by the plurality of the battery cells 211 arranged in the first direction X. A surface on the first side Y1 and a surface (not illustrated) on the second side Y2 in the second direction Y of the plurality of battery cells 211 constituting the assembled battery are electrode arrangement surfaces 211a (the electrode arrangement surface 211a on the second side Y2 is not illustrated) on which electrodes 211n of the respective battery cells 211 are arranged. Each of the electrode arrangement surfaces 211a is a surface parallel to a surface including the first direction X and the third direction Z. In each of the battery cells 211, a positive electrode is disposed on one electrode arrangement surface 211a of the two electrode arrangement surfaces 211a, and a negative electrode is disposed on another electrode arrangement surface 211a. The bus bar module 1 is provided on each of the two electrode arrangement surfaces 211a. Although the bus bar module 1 is formed in an elongated shape in the first direction X, only a part of the bus bar module 1 is illustrated in FIGS. 1 and 2. FIG. 3 is a perspective view of only a bus bar module case 100 included in the bus bar module 1 when viewed from the second side Y2 in the second direction Y.

The bus bar module 1 includes the bus bar module case 100, a bus bar 2, a wiring member 3, and a voltage detection terminal 4. The bus bar module case 100 is integrally formed of an insulating resin material. The bus bar module case 100 includes a case body 50 and a cover 40. The cover 40 is provided so as to be openable and closable with respect to the case body 50. The case body 50 includes a locked portion 12 of a lock portion 10, a bus bar cavity 20 that accommodates the bus bar 2 therein, and a wiring path 30 in which the wiring member 3 is provided. The wiring path 30 includes a trunk wiring path 35 in which a trunk line 3a of the wiring member 3 is provided and a branch wiring path 36 in which a branch portion 3b of the wiring member 3 is provided. The bus bar module case 100 will be described in detail later.

The bus bar 2 connects the adjacent electrodes 211n of the plurality of battery cells 211 arranged side by side in the first direction X. The bus bar 2 is a conductor formed of a conductive metal plate. The bus bar 2 is formed in a substantially long rectangular shape with the first direction X as a longitudinal direction. The bus bar 2 has an electrode connection hole 2a which is a round hole passing therethrough. The bus bar 2 is fixed to each of the electrodes 211n through the electrode connection hole 2a. The bus bar 2 connects, for example, two adjacent battery cells 211 in series. In this case, the bus bar 2 connects the positive electrode of one battery cell 211 and the negative electrode of the other battery cell 211. The bus bar 2 may be configured to connect the two adjacent battery cells 211 in parallel. In addition, the bus bar 2 connected to one electrode 211n may be provided at an end of the bus bar module 1. Although the bus bar 2 is illustrated in a substantially flat plate shape in the present embodiment, the bus bar 2 may have a projecting portion following a beam portion 22 described later so as not to interfere with the beam portion 22.

The wiring member 3 is, for example, a flat wiring member such as a flexible printed wiring board. When the wiring member 3 is a flexible printed wiring board, the wiring member 3 includes a base film, a coverlay, and a conductive layer. The base film and the coverlay are flexible insulating resin layers. The conductive layer is interposed between and protected by the base film and the coverlay. The conductive layer is, for example, a conductive metal foil and includes a plurality of circuit patterns connected to the bus bar 2. The wiring member 3 includes the trunk line 3a arranged in the first direction X and the branch portion 3b extending from the trunk line 3a to the first side Z1 in the third direction Z.

The voltage detection terminal 4 is electrically connected to the bus bar 2 and the branch portion 3b of the wiring member 3. The voltage detection terminal 4 detects a voltage between the electrodes of the bus bar 2, and the voltage of each of the battery cells 211 is monitored by a monitoring device (not illustrated) connected to the wiring member 3.

The bus bar cavity 20 in the case body 50 of the bus bar module case 100 is formed in a substantially frame shape in which the first side Y1 and the second side Y2 in the second direction Y are open and includes a side wall 21 erected around an end edge 2b serving as an outer periphery of the bus bar 2. The side wall 21 is formed in a substantially long rectangular shape with the first direction X as a longitudinal direction so that a substantially plate-shaped member is erected substantially perpendicular to the electrode arrangement surface 211a and surrounds the bus bar 2.

The side wall 21 includes a plate-shaped first side wall 21a and a plate-shaped second side wall 21b extending in the first direction X with a plate surface facing in the third direction Z. The first side wall 21a is provided on the first side Z1 in the third direction Z, and the second side wall 21b is provided on the second side Z2. The side wall 21 includes a plate-shaped third side wall 21c and a plate-shaped fourth side wall 21d extending in the third direction Z with a plate surface facing the first direction X. The third side wall 21c is provided on first side X1 in the first direction X, and the fourth side wall 21d is provided on the second side X2. The third side wall 21c includes an upper third side wall 21c1 on the first side Z1 in the third direction Z and a lower third side wall 21c2 on the second side Z2. The fourth side wall 21d is connected to the first side wall 21a and the second side wall 21b at a substantially right angle. The first side wall 21a is connected to the upper third side wall 21c1 at a substantially right angle. The second side wall 21b is connected to the lower third side wall 21c2 at a substantially right angle.

The upper third side wall 21c1 is located further on the first side X1 in the first direction X than the lower third side wall 21c2 is. Therefore, the upper third side wall 21c1 and the lower third side wall 21c2 are separated in the first direction X. A portion where the upper third side wall 21c1 and the lower third side wall 21c2 are separated from each other is the branch wiring path 36 of the wiring path 30 in which the branch portion 3b of the wiring member 3 is arranged. An end of the upper third side wall 21c1 on the second side Z2 in the third direction Z and an end of the lower third side wall 21c2 on the first side Z1 overlap with each other when viewed in the first direction X.

The voltage detection terminal 4 is disposed on the first side Z1 of the lower third side wall 21c2 in the third direction Z and on the second side X2 of the upper third side wall 21c1 in the first direction X. The branch portion 3b of the wiring member 3 is electrically connected to the voltage detection terminal 4. The locked portion 12 to which a locking projection 11 of the cover 40 described later is locked is provided on a surface on the first side Z1 in the third direction Z which is an outer surface of the first side wall 21a. The locked portion 12 is formed in a through-hole shape. In addition, the beam portion 22 is provided in a substantially central portion in the first direction X inside the bus bar cavity 20 from the first side wall 21a to the second side wall 21b. The beam portion 22 has a substantially U-shaped cross section parallel to a plane including the first direction X and the second direction Y. The beam portion 22 is provided such that the substantially U-shaped opening side faces the second side Y2 in the second direction Y. The side wall 21 is provided with a plurality of bus bar locking portions 29. Each of the bus bar locking portions 29 is formed in a plate spring shape to which an elastic force is applied by forming slits on both sides. The bus bar 2 accommodated in the bus bar cavity 20 can be fixed by the bus bar locking portions 29.

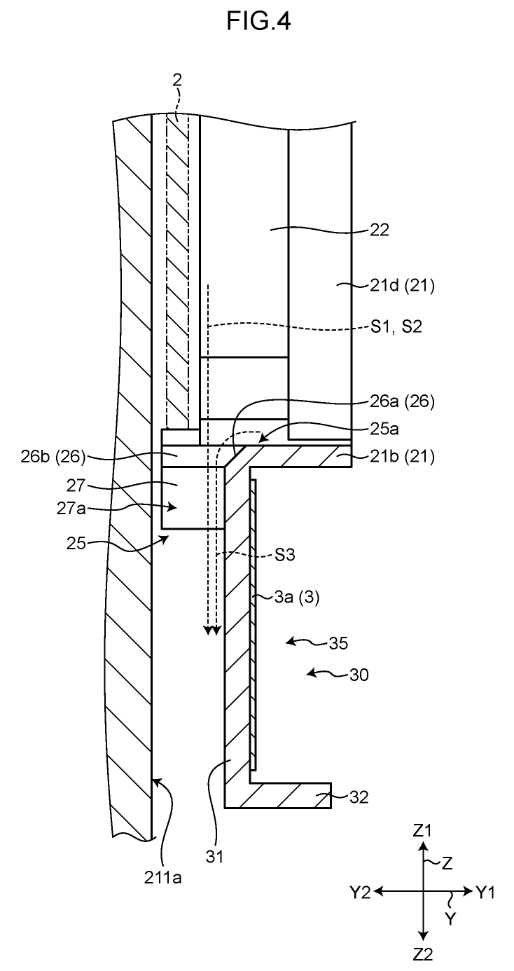

As illustrated in FIGS. 1 and 4, the trunk wiring path 35 of the wiring path 30 in the bus bar module case 100 is provided on the second side Z2 in the third direction Z of the second side wall 21b of the bus bar cavity 20 (here, a lower side of the second side wall 21b in the vertical direction in a state where the bus bar module 1 is installed in the plurality of battery cells 211 (hereinafter, the state may be simply referred to as an "installed state")). The wiring path 30 has a wall 31 extending outside the side wall 21 of the bus bar cavity 20. In the present embodiment, the wall 31 extends from a surface on the second side Z2 in the third direction Z, which is an outer surface of the second side wall 21b, to the second side Z2 and is formed in a substantially plate shape with a plate surface facing in the second direction Y. A lower end, which is an end on the second side Z2 in the third direction Z of the wall 31, is provided with a bottom plate 32 that projects from the lower end toward the first side Y1 in the second direction Y. The bottom plate 32 is provided with a plate surface facing in the third direction Z. The trunk wiring path 35 of the wiring path 30 is formed by an outer surface (a surface on the second side Z2 in the third direction Z) of the second side wall 21b, a surface on the first side Y1 in the second direction Y of the wall 31, and an upper surface (a surface on the first side Z1 in the third direction Z) of the bottom plate 32. In the trunk wiring path 35, the trunk line 3a of the wiring member 3 is arranged. The trunk wiring path 35 is formed long in the first direction X.

As illustrated in FIG. 1, the cover 40 having a substantially plate shape is provided on the second side Z2 in the third direction Z of the trunk wiring path 35 of the wiring path 30. The cover 40 is connected to the wiring path 30 via a hinge portion 45. The hinge portion 45 is formed in a thin plate shape and is flexible. The cover 40 includes a trunk protecting portion 41 covering the trunk wiring path 35 and a branch protecting portion 42 covering the branch wiring path 36. The hinge portion 45 is connected to the trunk protecting portion 41 and the bottom plate 32 of the wiring path 30. A voltage detection terminal protecting portion 42a projecting toward the second side X2 in the first direction X is formed at a leading end of the branch protecting portion 42. The voltage detection terminal protecting portion 42a is a portion covering the voltage detection terminal 4 and mainly covers a portion where a potted chip fuse is disposed in the voltage detection terminal 4. The voltage detection terminal protecting portion 42a is provided with the locking projection 11 projecting toward the first side Y1 in the second direction Y in a state where the cover 40 is open.

As illustrated in FIG. 2, when the cover 40 is closed, the trunk protecting portion 41 covers the trunk line 3a of the wiring member 3, and the branch protecting portion 42 covers the branch portion 3b of the wiring member 3. The voltage detection terminal protecting portion 42a of the branch protecting portion 42 covers a main portion of the voltage detection terminal 4. The cover 40 is locked in a closed state by inserting the locking projection 11 into the locked portion 12. The lock portion 10 includes the locking projection 11 and the locked portion 12. The lock portion 10 is locked in a state where the cover 40 covers the wiring member 3 (the wiring path 30).

As illustrated in FIGS. 3 and 4, the second side wall 21b of the side wall 21 is provided with a plurality of drain holes 25. Each of the drain holes 25 is provided in the second side wall 21b which is the side wall 21 on the installation surface 211b side of the plurality of battery cells 211. That is, each drain hole 25 is provided in the second side wall 21b of the side wall 21, which is located on a lower side in the vertical direction in the installed state. At this time, the bus bar 2 is attached with a plate surface facing in the second direction Y. In each bus bar cavity 20, a total of two of the plurality of drain holes 25 are provided, one on the first side X1 and one on the second side X2 of the beam portion 22 of the bus bar cavity 20 in the first direction X. That is, the drain holes 25 are disposed corresponding to the electrodes 211n. Each of the drain holes 25 is a hole that passes through the second side wall 21b in the third direction Z and opens so as to communicate the inside and the outside of the bus bar cavity 20. Each drain hole 25 is formed in a substantially long rectangular shape with the first direction X as a longitudinal direction. The second side Y2 of each drain hole 25 in the second direction Y is open. Each drain hole 25 is provided further on the battery cell 211 side (the second side Y2 in the second direction Y) than the wall 31 in the installed state is.

Tapered guide portions 26a and 26b are provided at an inner edge portion 26 of the bus bar cavity 20 in each drain hole 25. The tapered guide portions 26a and 26b are inclined so as to reduce a cross-sectional area of the drain hole 25 (the cross-sectional area of the drain hole 25 parallel to a plane including the first direction X and the second direction Y) from the inside to the outside of the bus bar cavity 20. Here, the wall 31 of the wiring path 30 is provided on a long side 25a of the substantially long rectangular shape of each drain hole 25 (particularly, see FIG. 4). In other words, the wall 31 is provided along the long side of the drain hole 25. Each of two short sides 25b of the substantially long rectangular shape of the edge portion 26 of the drain hole 25 is provided with a rib 27 extending from the tapered guide portion 26b of the edge portion 26 of the short side 25b to the outside of the bus bar cavity 20. The rib 27 is provided further on the battery cell 211 side (the second side Y2 in the second direction Y) than is the wall 31. The rib 27 is formed in a substantially plate shape with a plate surface facing in the first direction X. An end of the rib 27 on the first side Y1 in the second direction Y is connected to a surface (a surface on the battery cell 211 side) of the wall 31 on the second side Y2. An inclined surface of the tapered guide portion 26a is connected to the surface of the wall 31 on the battery cell 211 side. An inclined surface of each of the tapered guide portions 26b is connected to a surface 27a of the rib 27 on the drain hole 25 side.

For example, the drain hole 25 is formed such that water droplets generated due to condensation or the like in the bus bar cavity 20 can be discharged from the inside to the outside of the bus bar cavity 20. A part of the water droplets attached to a surface of the bus bar 2 on the first side Y1 in the second direction Y is discharged from the inside to the outside of the bus bar cavity 20 by the weight of the water droplets as in a flow path S1 indicated by broken lines in FIGS. 2 and 4. Specifically, the water droplets condensed and attached to the bus bar 2 fall on an inner side surface of the second side wall 21b (an upper surface of the second side wall 21b) and fall to the outside of the bus bar cavity 20 along the surface 27a of the rib 27 on the drain hole 25 side. The water droplets on a surface of the bus bar 2 immediately above the drain hole 25 directly fall to the outside of the bus bar cavity 20 through the drain hole 25 as in a flow path S2 indicated by broken lines. Further, a part of the water droplets discharged from the drain hole 25 is discharged to the outside of the bus bar cavity 20 via the rib 27 and the tapered guide portion 26a on the long side 25a and falls along the surface of the wall 31 on the battery cell 211 side.

The bus bar module case 100 described above includes the bus bar cavity 20 that accommodates therein the bus bar 2 connected to the electrodes 211n of the battery cells 211 in the plurality of battery cells 211 arranged side by side and includes the side wall 21 erected around the end edge 2b of the bus bar 2, and the side wall 21 is provided with the drain hole 25 that communicates the inside and the outside of the bus bar cavity 20. In addition, the bus bar module 1 includes the bus bar 2, the wiring member 3, and the bus bar module case 100. As a result, even when water droplets are generated on a surface of the bus bar 2 due to condensation of the bus bar 2, the water droplets do not accumulate on the upper surface side of the second side wall 21b, and the water droplets can be discharged through the drain hole 25. Therefore, the treatment of the water droplets accumulated in the bus bar cavity 20 can be appropriately realized. In addition, the edge portion 26 of the drain hole 25 includes the tapered guide portions 26a and 26b inclined so as to reduce the cross-sectional area of the drain hole 25 from the inside to the outside of the bus bar cavity 20. As a result, the water droplets inside the bus bar cavity 20 are smoothly guided to the drain hole 25 by the inclined tapered guide portions 26a and 26b.

In addition, the bus bar cavity 20 includes the rib 27 extending from the edge portion 26 of the drain hole 25 to the outside of the bus bar cavity 20. As a result, the water droplets discharged from the drain hole 25 do not accumulate on a lower surface of the second side wall 21b or the like and can be appropriately discharged to the outside of the bus bar cavity 20 via the rib 27.

Further, the wall 31 extending from the second side wall 21b of the side wall 21 to the outside of the bus bar cavity 20 is included, and the rib 27 is provided on the battery cell 211 side of the wall 31 and is connected to the wall 31. As a result, the water droplets discharged from the drain hole 25 can flow along the surface of the wall 31 on the battery cell 211 side and fall downward, so that the water droplets can be prevented from coming into contact with the battery cell 211.

In addition, the drain hole 25 is formed in a long rectangular shape, the wall 31 is provided on the long side 25a of the long rectangular shape of the drain hole 25, and the rib 27 is provided on each of the short sides 25b of the long rectangular shape of the drain hole 25. As a result, it is not necessary to provide a hole in the wall 31 when the drain hole 25, the wall 31, and the rib 27 are formed by injection molding, and injection molding can be performed satisfactorily. Since the drain hole 25 is located further on the battery cell 211 side than the wall 31 is, the water droplets accumulated on the upper surface of the second side wall 21b can be reliably guided to the surface of the wall 31 on the battery cell 211 side.

In addition, the second side wall 21b of the side wall 21 provided with the drain hole 25 is located further on the installation surface 211b side of the plurality of battery cells 211 than the bus bar 2 is. That is, the drain hole 25 is provided in the second side wall 21b, of the side wall 21 forming the bus bar cavity 20, located on the lower side in the vertical direction in the installed state. As a result, the water droplets can be discharged from the drain hole 25 by the weight of the water droplets.

The bus bar module case and the bus bar module according to the above-described embodiment of the present invention are not limited to the above-described embodiment, and various modifications can be made within the scope described in the claims.

In the above description, the rib 27 is provided so as to be connected to the wall 31, but the rib 27 may be provided separately from the wall 31. In addition, the drain hole 25 is not limited to a substantially long rectangular shape, and an appropriate form can be adopted. Although the tapered guide portions 26a and 26b are provided in the entire region of the edge portion 26 of the drain hole 25, the tapered guide portions 26a and 26b may be provided in a part of the edge portion 26. In addition to a flexible printed wiring board, a flexible flat cable or an electric wire can be used as the wiring member 3.

The bus bar module case and the bus bar module according to the present embodiment may be configured by appropriately combining the components of the embodiment and the modifications described above.

A bus bar module case and a bus bar module according to the present embodiment achieve an effect of appropriately realizing treatment of water droplets accumulated in a bus bar cavity.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A bus bar module case comprising:
a bus bar cavity that accommodates therein a bus bar connected to an electrode of each of a plurality of battery cells arranged side by side, and includes a side wall erected around an end edge of the bus bar, wherein the side wall is provided with a drain hole that communicates an inside and an outside of the bus bar cavity, and the drain hole has an edge portion including a tapered guide portion inclined to reduce a cross-sectional area of the drain hole from the inside to the outside of the bus bar cavity.

2. The bus bar module case according to claim 1, wherein the bus bar cavity includes a rib extending from the edge portion of the drain hole to the outside of the bus bar cavity.

3. The bus bar module case according to claim 2, further comprising:
a wall extending from the side wall to the outside of the bus bar cavity, wherein the rib is provided on the battery cell side of the wall and is connected to the wall.

4. The bus bar module case according to claim 3, wherein the drain hole is formed in a long rectangular shape, and the wall is provided on a long side of the long rectangular shape of the drain hole, and the rib is provided on a short side of the long rectangular shape of the drain hole.

5. The bus bar module case according to claim 1, wherein the side wall is located further on an installation surface side of the plurality of battery cells than the bus bar is.

6. The bus bar module case according to claim 2, wherein the side wall is located further on an installation surface side of the plurality of battery cells than the bus bar is.

7. The bus bar module case according to claim 3, wherein the side wall is located further on an installation surface side of the plurality of battery cells than the bus bar is.

8. The bus bar module case according to claim 4, wherein the side wall is located further on an installation surface side of the plurality of battery cells than the bus bar is.

9. A bus bar module comprising:
a bus bar connected to an electrode of each of a plurality of battery cells arranged side by side; a wiring member electrically connected to the bus bar; and
a bus bar module case including a bus bar cavity that accommodates therein the bus bar and includes a side wall erected around an end edge of the bus bar, in which the side wall is provided with a drain hole that communicates an inside and an outside of the bus bar cavity, and the drain hole has an edge portion including a tapered guide portion inclined to reduce a cross-sectional area of the drain hole from the inside to the outside of the bus bar cavity.
